(19) United States
(12) Patent Application Publication
(10) Pub. No.: US 2005/0141420 A1
(43) Pub. Date: Jun. 30, 2005

(54) Transmission coordination for SDMA downlink communication

(76) Inventors: Qinghua Li, Sunnyvale, CA (US); Minnie Ho, Los Altos, CA (US); Adrian P. Stephens, Cambridge (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/745,871

(22) Filed: Dec. 24, 2003

(51) Int. Cl. H04L 1/00

(52) U.S. Cl. 370/230

(57) ABSTRACT

According to some embodiments, a technique is provided that coordinates transmission of frames to reduce collisions. Frames are coordinated according to, for example, operation type, frame length, and solicited response. A base station gains access to a wireless medium and transmits multiple coordinated frames to multiple communication units. The transmissions to the multiple communication units may be substantially simultaneous in that at least a portion of the different frames are transmitted at the same time. The different frames may be substantially back-end aligned where the maximum difference between the termination time instances of the frame transmissions is controlled to reduce collisions.

### BACKGROUND

### DESCRIPTION OF THE RELATED ART

To address the problem of ever-increasing bandwidth requirements that are placed on wireless data communications systems, various techniques are being developed to allow multiple communication units to communicate with a single base station by sharing a single channel. In one such technique, a base station may transmit or receive separate signals to or from multiple communication units at the same time on the same frequency, provided the communication units are located in sufficiently different directions from the base station. For transmission from the base station, different signals may be simultaneously transmitted from each of separate spaced-apart antennas so that the combined transmissions are directional, that is, the signal intended for each communication unit may be relatively strong in the direction of that communication unit and relatively weak in other directions. This type of transmission is referred to as spatial division multiple access (SDMA). In a similar manner, the base station may receive the combined signals from multiple independent communication units at the same time on the same frequency through each of separate spaced-apart antennas, and separate the combined received signals from the multiple antennas into the separate signals from each communication unit through appropriate signal processing so that the reception is directional.

Note that although a base station may have multiple antennas, one antenna typically cannot receive data while another antenna transmits data. Thus, multiple communication units can transmit overlapping data to a base station and a base station can transmit overlapping data to multiple communication units. Collisions occur when a communication unit transmits data during base station transmissions.

Under currently developing specifications, such as the IEEE 802.11 standards (IEEE is the acronym for the Institute of Electrical and Electronic Engineers, 3 Park Avenue, 17th floor, New York, N.Y.), physical and virtual carrier sensing may be used to reduce collisions. Physical carrier sensing refers to the physical sensing of active signals in the wireless medium. Virtual carrier sensing refers to, for example, reservation information distributed in previous transmission(s) announcing impending use of the medium to reduce collisions. However, because the base station may transmit directionally to multiple communication units, a communication unit may not be able to physically detect a transmission to another communication unit and additionally may not receive and decode distributed reservation information. Thus, physical and virtual carrier sensing may not be available and a communication unit may incorrectly assume the medium is available.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a diagram of a network for wireless communications according to an embodiment of the invention.

FIG. 2 illustrates a block diagram of a communication unit in accordance with some embodiments of the present invention.

FIG. 3 illustrates coordinated spatial division multiple access (SDMA) downlink transmissions using IEEE 802.11 contention-free operation according to an embodiment of the present invention.

FIG. 4 illustrates other coordinated SDMA downlink transmissions using IEEE 802.11 contention-free operation according to an embodiment of the present invention.

FIG. 5 illustrates other coordinated SDMA downlink transmissions using IEEE 802.11 contention-free operation according to an embodiment of the present invention.

FIG. 6 illustrates coordinated SDMA downlink transmissions protected by a clear to send (CTS) frame according to an embodiment of the present invention.

FIG. 7 illustrates coordinated SDMA downlink transmissions protected by a request to send (RTS) frame according to an embodiment of the present invention.

FIG. 8 illustrates a flow diagram for coordinated SDMA downlink transmissions according to an embodiment of the present invention.

The use of the same reference symbols in different drawings indicates similar or identical items.

### DESCRIPTION OF THE EMBODIMENT(S)

According to some embodiments, a technique is provided that coordinates transmission of multiple frames to multiple communication units to reduce collisions while permitting use of a large installed base of omni-directional transmission capable communication units. A base station may gain access to the medium and transmit multiple coordinated frames to multiple communication units. Frames are coordinated according to, for example, operation type, frame length, and solicited response. The transmissions to the multiple communication units may be substantially simultaneous in that at least a portion of the different frames are transmitted at the same time. The different frames may be substantially back-end aligned where the maximum difference between the termination time instances of the frame transmissions is controlled to reduce collisions. Protocol operations may be transmitted directionally to communication units allowing for backward compatibility with omni-directional communication units.

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

In keeping with common industry terminology, the terms “base station,” “access point,” and “AP” may be used interchangeably herein to describe an electronic device that may communicate wirelessly and substantially simultaneously with multiple other electronic devices, while the terms “communication unit” and “STA” may be used interchangeably to describe any of those multiple other electronic devices, which may have the capability to be moved and still communicate, though movement is not a requirement. However, the scope of the invention is not limited to devices that are labeled with those terms.

Similarly, the terms “spatial division multiple access” and SDMA may be used interchangeably. As used herein, these terms are intended to encompass any communication technique in which different signals may be transmitted by different antennas substantially simultaneously from the same device such that the combined transmitted signals result in different signals intended for different devices being transmitted substantially in different directions on the same frequency, and/or techniques in which different signals may be received substantially simultaneously through multiple antennas on the same frequency from different devices in different directions and the different signals may be separated from each other through suitable processing. The term “same frequency,” as used herein, may include slight variations in the exact frequency due to such things as bandwidth tolerance, Doppler shift adaptations, parameter drift, etc. Two or more transmissions to different devices are considered substantially simultaneous if at least a portion of each transmission to the different devices occurs at the same time, but does not imply that the different transmissions must start and/or end at the same time, although they may. Similarly, two or more receptions from different devices are considered substantially simultaneous if at least a portion of each reception from the different devices occurs at the same time, but does not imply that the different transmissions must start and/or end at the same time, although they may. Variations of the words represented by the term SDMA may sometimes be used by others, such as but not limited to substituting “space” for “spatial,” or “diversity” for “division”. The scope of various embodiments of the invention is intended to encompass such differences in nomenclature.

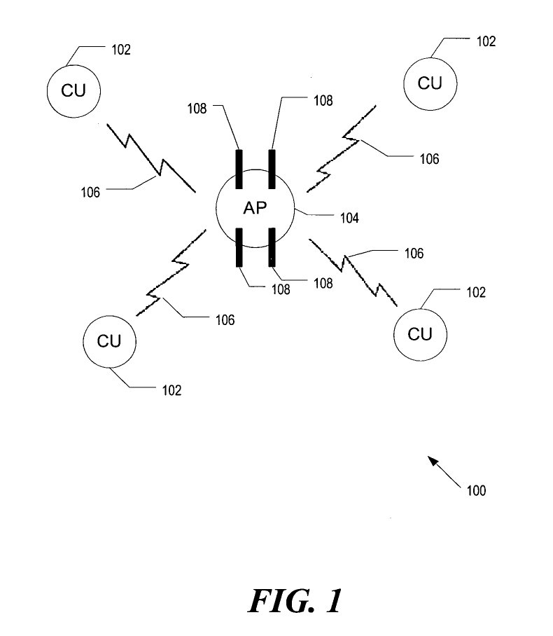

FIG. 1 illustrates a diagram of a network for wireless communications according to an embodiment of the invention. A communications network 100 may include one or more communication units (CUs) 102, which may communicate with one or more base stations or access points (AP) 104 over wireless communication links 106. CUs 102 may include, for example, mobile units such as personal digital assistants (PDAs), laptop and portable computers with wireless communication capability, web tablets, wireless telephones, wireless headsets, pagers, instant messaging devices, MP3 players, digital cameras, and other devices that may receive and/or transmit information wirelessly. In some embodiments, CUs 102 may also include access points (APs), although the scope of the invention is not limited in this respect. AP 104 may transmit multiple coordinated frames to each of multiple ones of CUs 102 on the same frequency substantially simultaneously and may substantially back-end align the multiple frames, and may receive different signals from each of multiple ones of CUs 102 on the same frequency reducing collisions.

Although AP 104 is shown with four antennas 108 to communicate wirelessly with up to four CUs 102 at a time using spatial division multiple access (SDMA) techniques, other embodiments may have other arrangements (for example, AP 104 may have two, three, or more than four antennas). Each of CUs 102 may have at least one antenna to communicate wirelessly with AP 104. In some embodiments antennas 108 may be adapted to operate omni-directionally, but in other embodiments antennas 108 may be adapted to operate directionally. In some embodiments CU 102 antenna(s) may be adapted to operate omni-directionally, for example, in older CUs, but in other embodiments CU 102 antenna(s) may be adapted to operate directionally. In some embodiments CUs 102 may be in fixed locations, but in other embodiments at least some of CUs 102 may be mobile. In some embodiments AP 104 may be in a fixed location, but in other embodiments AP 104 may be mobile.

In some embodiments, CUs 102 and AP 104 may communicate in accordance with one or more communication standards, such as one of the Institute of Electrical and Electronics Engineers (IEEE) 802.11 standards although the scope of the invention is not limited in this respect. Other wireless local area network (WLAN) and wireless wide area network (WAN) communication techniques may also be suitable for communications between CUs 102 and AP 104.

In addition to facilitating communications between CUs 102, in some embodiments, APs 104 may be coupled with one or more networks, such as an intranet or the Internet, allowing CUs 102 to access such networks. Although FIG. 1 illustrates point-to-point communications (for example, where an AP synchronizes with a network), embodiments of the present invention may also be suitable to point-to-multipoint communications, including peer-to-peer communications in which CUs may share the responsibility for synchronizing with a network.

CUs 102 and AP 104 may be referred to herein as a transmitting unit, a receiving unit, or both. The terms “transmitting” and “receiving” are applied to CUs 102 and AP 104 for ease in understanding the embodiments of the present invention. It shall be understood that CUs 102 and AP 104 may include both transmitting and receiving capability to establish communications therebetween.

Transmissions from AP 104 to one of CUs 102 may be referred to as downlink transmissions. Transmissions from one of CUs102 to AP 104 may be referred to as uplink transmissions.

Communication system 100 may operate according to a point coordination function (PCF) in which the coordination function logic is active in only one station, for example, AP 104, at any given time that the network is in operation. Alternatively, communication system 100 may operate according to a distributed coordination function (DCF) where the same coordination function logic is active in multiple stations, including communication units 102 and AP 104 whenever the network is in operation.

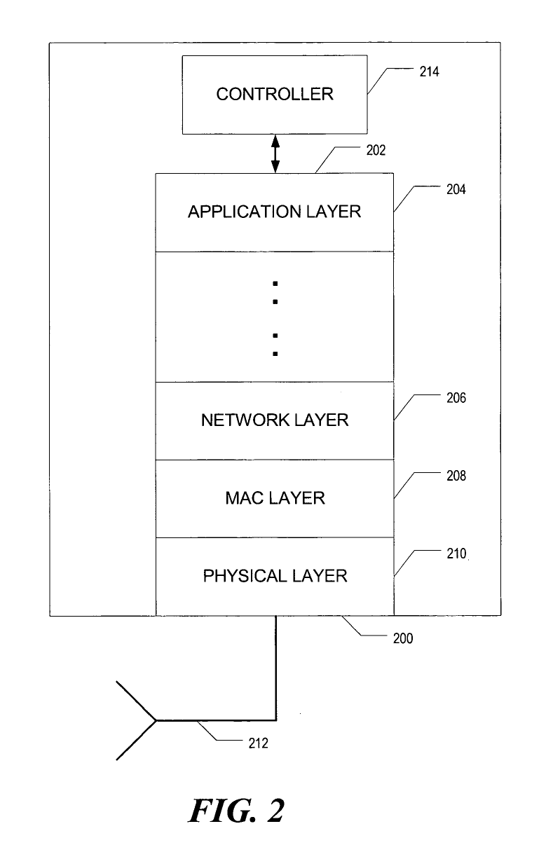

FIG. 2 illustrates a block diagram of a communication unit in accordance with some embodiments of the present invention. Communication unit 200 may be suitable for use as one or more of CUs 102 (FIG. 1) and/or a high-throughput (HT) AP such as AP 104 (FIG. 1), although other devices may also be suitable. Among other things CU 200 may include protocol stack 202, which may include one or more layers such as application layer 204, network layer 206, medium-access-control (MAC) layer 208, and physical layer (PHY) 210. Physical layer 210 may couple with antenna 212. CU 200 may also include controller 214 to coordinate the activity of the various elements of CU 200 and protocol stack 202. Antenna 212 may include a directional or omni-directional antenna, including, for example, a dipole antenna, a monopole antenna, a loop antenna, a microstrip antenna or other type of antenna suitable for reception and/or transmission of radio frequency (RF) signals which may be communicated by CU 200.

Although CU 200 is illustrated as having several separate functional elements, one or more of the functional elements may be combined and may be implemented by combinations of software-configured elements, such as processing elements including digital signal processors (DSPs), and/or other hardware elements. For example, processing elements may include one or more microprocessors, DSPs, application specific integrated circuits (ASICs), and combinations of various hardware and logic circuitry for performing at least the functions described herein.

Physical layer 210 may generate a physical-layer packet format used to transport transmitted physical layer service data units (SDUs) to peers under the control of MAC layer 208. MAC layer 208 may control access to the medium and may select operating modes of physical layer 210. MAC layer 208 maybe responsible for determining operating channels to select, and determining operating modes may be used within a wireless network. MAC layer 208 may also buffer network data to be transmitted, and in some embodiments, may choose modes of operation of physical layer 210 based on quality of service (QoS) requirements of specific streams of network data.

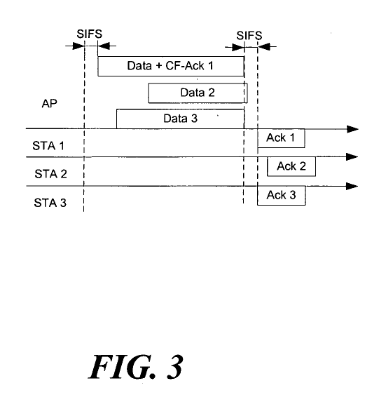

FIG. 3 illustrates coordinated SDMA downlink transmissions using IEEE 802.11 contention-free operation according to an embodiment of the present invention. As illustrated, AP and STA1, STA2 and STA3 communicate in accordance with one or more communication standards, such as one of the Institute of Electrical and Electronics Engineers (IEEE) 802.11 standards although the scope of the invention is not limited in this respect. During a contention-free period in PCF, multiple communication units, STA 1, STA 2 and STA 3, may not initiate frame exchange sequences, that is, the STAs transmit only if the AP solicits a response. For example, as illustrated in FIG. 3, STAs can transmit an acknowledgement frame (Ack) after receiving a data (or management) frame directed to the STA.

The AP may transmit multiple coordinated frames including Data frames and/or Data+CF-Ack frames compatible with an IEEE 802.11 standard to parallel STAs. Frames transmissions are coordinated according to, for example, protocol operation, frame length, and solicited response. Data frames may contain data and additional control information. Data+CF-Ack frames may contain “piggyback” acknowledgement of previously received data and additional control information. According to IEEE 802.11 protocol, for example, any time data is sent, a frame containing an acknowledgement (Ack or CF-Ack) is required to be sent within a specified time period. If an acknowledgement is not received, the data may be retransmitted. Because an AP is sending multiple data frames to multiple STAs, the AP may coordinate transmissions to reduce data re-transmissions.

Referring to FIG. 3, Data+CF-Ack 1 frame is a directional transmission from AP to STA 1. Data 2 is a directional transmission from AP to STA 2. Data 3 is a directional transmission to STA 3. By coordinating multiple frames according to protocol operations, for example, by coordinating large data transmission frames together, throughput can be improved.

The frame transmissions from the AP may be substantially back-end aligned, that is, the maximum difference between the termination time instances of frame transmissions is controlled to reduce collisions. The termination time instances do not need to be simultaneous to maximize the throughput. However, the termination time instances are coordinated to end so that response frames, such as Acks, are received in a timely fashion and do not collide with AP transmissions.

After transmitting the coordinated frames, the AP then switches its antennas to receive mode to receive acknowledgements (Acks) from the STAs. The Acks from the STAs may be omni-directional transmissions, allowing for backward compatibility with the installed base of IEEE 802.11 compliant STAs. Although STA 2 may detect the transmission of STA 1's ACK, STA 2 transmits an ACK because protocol requires acknowledgements to be sent within a specified time frame. For example, the IEEE 802.11 standard requires an ACK (or CF-ACK) to be sent without respect to the channel idle/busy status.

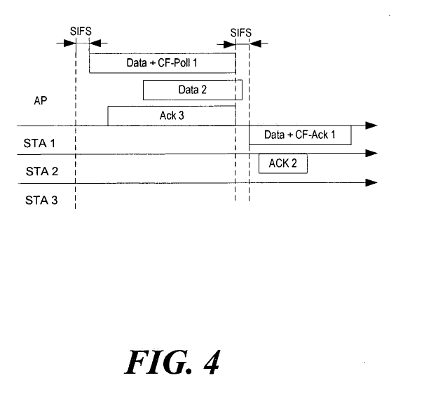

FIG. 4 illustrates other coordinated SDMA downlink transmissions using IEEE 802.11 contention-free operation according to an embodiment of the present invention. As illustrated, AP and STA1, STA2 and STA3 communicate in accordance with one or more communication standards, such as one of the Institute of Electrical and Electronics Engineers (IEEE) 802.11 standards although the scope of the invention is not limited in this respect. Here, STA 1 transmits data after receiving a frame with a contention-free-poll (CF-Poll). A poll is a request for transmission of data. The AP sends multiple coordinated frames compatible with an IEEE 802.11 standard, including Data, Data+CF-Poll, ACK, or Data+CF-ACK (not shown) frames. Note that the AP sends these frames directionally to each STA. The AP may add a single CF-Poll in the coordinated frames to request data from a STA. The single CF-Poll limit ensures that response frames are coordinated and the AP need only respond to one data transmission. If more than one CF-Poll were included in the coordinated frames and the response data frames were different lengths, the AP might not be able to timely respond to both data frames because the AP cannot receive and send frames at the same time. This also assumes that the length of the Data response is longer than the Ack.

As illustrated in FIGS. 3 and 4, the AP can reduce collisions by using PCF and coordinating when and what the STAs transmit.

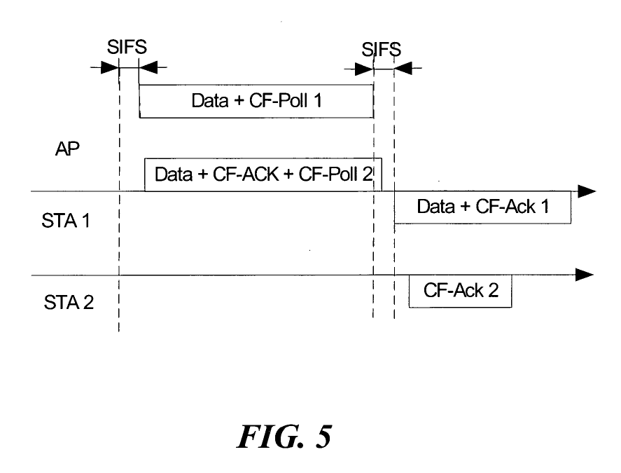

FIG. 5 illustrates other coordinated SDMA downlink transmissions using IEEE 802.11 contention-free operation according to an embodiment of the present invention. As illustrated, AP and STA1, STA2 and STA3 communicate in accordance with one or more communication standards, such as one of the Institute of Electrical and Electronics Engineers (IEEE) 802.11 standards although the scope of the invention is not limited in this respect. As illustrated, the AP sends Data frames along with multiple CF-Polls in the parallel group to request uplink traffic. The AP sends a Data+CF-Poll frame directionally to STA1, and a Data+CF-Ack+CF-Poll frame to STA 2. Here, STA 2 does not respond with data, thus does not need an Ack from the AP. However, this response may not be guaranteed.

If the termination time instances of the uplink frames from multiple STAs that require acknowledgments are close enough together, the AP can timely acknowledge both transmissions and retransmission in the uplink does not occur. Note that only uplink frames requesting an acknowledgement are relevant to the time window. If the termination time instances spreads over the time window, the AP still receives the acknowledgements from the STAs but may not acknowledge the received uplink Data frames within the required time. If the AP sends out the acknowledgements late, retransmission in the uplink may occur, dependent on the ACK timeout implementation on the STAs.

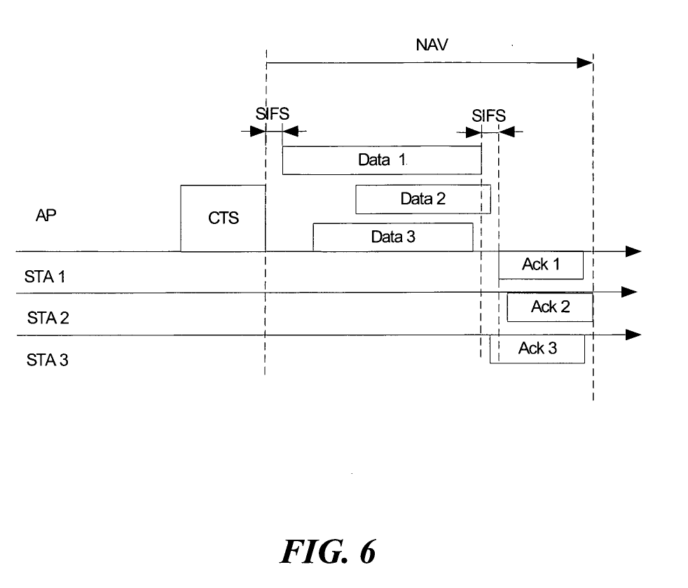

FIG. 6 illustrates coordinated SDMA downlink transmissions protected by a clear to send (CTS) frame in DCF according to an embodiment of the present invention. As illustrated, AP and STA1, STA2 and STA3 communicate in accordance with one or more communication standards, such as one of the Institute of Electrical and Electronics Engineers (IEEE) 802.11 standards although the scope of the invention is not limited in this respect. As illustrated, the AP broadcasts reservation information in the form of a network-allocation-vector (NAV) to reduce STAs from interfering with directional transmissions. The NAV is broadcast using a CTS frame using nominally omni-directional radiation antennas. The STAs refrain from initiating transmissions while their NAV counter indicates that the medium is reserved. Data 1, Data 2 and Data 3 are directional transmissions to STA 1, STA 2 and STA 3, respectively. Note that the STAs can send acknowledgement transmissions, but not initiate new transmissions.

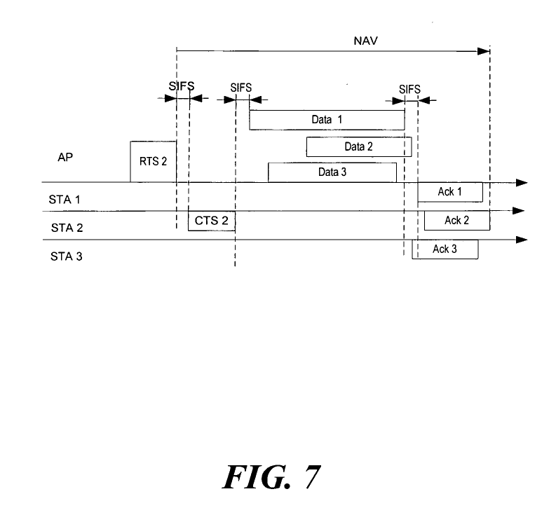

FIG. 7 illustrates coordinated SDMA downlink transmissions protected by a request to send (RTS) frame in DCF according to an embodiment of the present invention. As illustrated, AP and STA1, STA2 and STA3 communicate in accordance with one or more communication standards, such as one of the Institute of Electrical and Electronics Engineers (IEEE) 802.11 standards although the scope of the invention is not limited in this respect. As illustrated, the AP broadcasts reservation information in the form of a network-allocation-vector (NAV) to reduce STAs from interfering with directional transmissions. The NAV is broadcast using an RTS frame using nominally omni-directional radiation antennas. The STAs refrain from initiating transmissions while their NAV counter indicates that the medium is reserved.

Note that the data transmissions of FIGS. 6 and 7 are also substantially back-end aligned so that response Acks do not collide with AP transmissions.

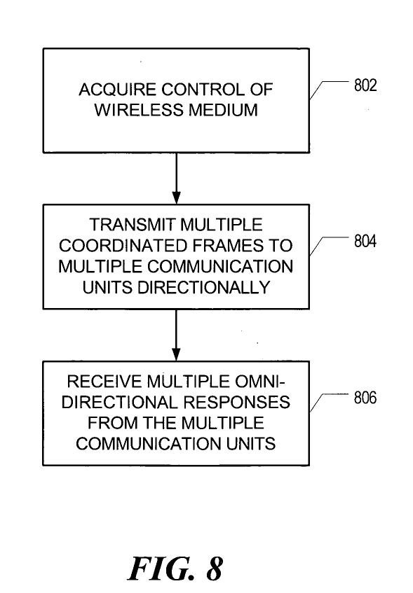

FIG. 8 illustrates a flow diagram for coordinated SDMA downlink transmissions according to an embodiment of the present invention. Control of the wireless medium is acquired, step 802. This may be accomplished in a number of ways. For example, in PCF, a base station has control of the transmissions over the wireless medium. In DCF, a base station can acquire control of the wireless medium by sending medium reservation information in, for example, a request to send or a clear to send frame as illustrated in FIGS. 6 and 7. Multiple coordinated frames may be sent to multiple communication units directionally, step 804. Multiple omni-directional responses are received from the multiple communication units, step 806.

Although one or more inventive aspects have been developed with reference to, or in the context of, an IEEE 802.11 implementation, those skilled in the art will appreciate that the invention is not so limited. That is, one or more embodiments of the claimed invention may well be practiced within a wireless metropolitan area network (WMAN), wireless personal area network (WPAN), or any other wireless communication environment without deviating from the scope and spirit of the present invention. In this regard, reference to IEEE 802.11 protocol data units are presented for purposes of illustrations, and not limitation, as protocol data units from other standards, for example, IEEE 802.15, IEEE 802.16, IEEE 802.20, 3G, 4G, UMTS, GPRS, EDGE, WUSB and the like may well be used when embodiments of the inventions are implemented within such standard-compliant communication networks.

The techniques described above may be embodied in a computer-readable medium for configuring a computer system to execute the method. The computer readable media may be permanently, removably or remotely coupled to system 100 or another system. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computer systems may be found in many forms including but not limited to mainframes, minicomputers, servers, workstations, personal computers, notepads, personal digital assistants, various wireless devices and embedded systems, just to name a few. A typical computer system includes at least one processing unit, associated memory and a number of input/output (I/O) devices. A computer system processes information according to a program and produces resultant output information via I/O devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

1. A method of communication comprising:
transmitting a first frame to a first communication unit; and
transmitting a second frame to a second communication unit;
wherein at least a portion of the first frame is simultaneously transmitted with the second frame;
wherein the first frame and the second frame are coordinated according to a first solicited response for the first frame and a second solicited response for the second frame.

2. The method as recited in claim 1, wherein the first frame and the second frame are further coordinated according to operation type.

3. The method as recited in claim 2, wherein the first frame and the second frame are data transmission frames.

4. The method as recited in claim 2, wherein the first frame and the second frame are Data frames compatible with an IEEE 802.11 standard.

5. The method as recited in claim 1, wherein only one of the first frame and the second frame includes a request for data.

6. The method as recited in claim 1, wherein only one of the first frame and the second frame is a frame containing a CF-Poll compatible with an IEEE 802.11 standard.

7. The method as recited in claim 1, wherein the first frame and the second frame are further coordinated according to a frame length of the first frame and a frame length of the second frame.

8. The method as recited in claim 7, wherein the first frame and the second frame are substantially back-end aligned.

9. The method as recited in claim 1, wherein the first frame and the second frame are directional transmissions.

10. The method as recited in claim 1, further comprising:
receiving a response from the first communication unit; and
receiving another response from the second communication unit;
wherein at least a portion of the response is simultaneously transmitted with the other response.

11. The method as recited in claim 10, wherein transmission of the first frame and transmission of the second frame are via directional transmissions and the response and the other response are via omni-directional transmissions.

12. The method as recited in claim 1, further comprising:
acquiring control of a wireless medium.

13. The method as recited in claim 12, wherein acquiring control of the wireless medium comprises:
setting a network allocation vector in a previous frame to reserve the wireless medium.

14. The method as recited in claim 13, wherein the previous frame is a clear to send frame that is sent omni-directionally.

15. The method as recited in claim 13, wherein the previous frame is a request to send frame that is sent omni-directionally.

16. An apparatus comprising:
a medium access control layer, coupled with at least a first communication unit and a second communication unit through a physical layer, to identify a first frame to be communicated to a first communication unit via the physical layer and to identify a second frame to be communicated to a second communication unit via the physical layer, wherein at least a portion of the first frame is simultaneously transmitted with the second frame, and wherein the first frame and the second frame are coordinated according to a first solicited response for the first frame and a second solicited response for the second frame.

17. The apparatus as recited in claim 16, wherein the first frame and the second frame are further coordinated according to operation type.

18. The apparatus as recited in claim 17, wherein the first frame and the second frame are data transmission frames.

19. The apparatus as recited in claim 17, wherein the first frame and the second frame are Data frames compatible with an IEEE 802.11 standard.

20. The apparatus as recited in claim 16, wherein only one of the first frame and the second frame includes a request for data.

21. The apparatus as recited in claim 16, wherein only one of the first frame and the second frame is a frame containing a CF-Poll compatible with an IEEE 802.11 standard.

22. The apparatus as recited in claim 16, wherein the first frame and the second frame are further coordinated according to a frame length of the first frame and a frame length of the second frame.

23. The apparatus as recited in claim 22, wherein the first frame and the second frame are substantially back-end aligned.

24. The apparatus as recited in claim 16, the medium access control layer further to receive a response from the first communication unit, and to receive another response from the second communication unit, wherein at least a portion of the response is simultaneously transmitted with the other response.

25. The apparatus as recited in claim 24, wherein transmission of the first frame and transmission of the second frame are via directional transmissions and the response and the other response are via omni-directional transmissions.

26. The apparatus as recited in claim 16, the medium access control layer further to acquire control of a wireless medium.

27. The apparatus as recited in claim 26, wherein to acquire control of the wireless medium comprises operations to:
set a network allocation vector in a previous frame to reserve the wireless medium.

28. The apparatus as recited in claim 27, wherein the previous frame is a clear to send frame that is sent omni-directionally.

29. The apparatus as recited in claim 27, wherein the previous frame is a request to send frame that is sent omni-directionally.

30. A machine-readable medium that provides instructions, which when executed by one or more processors, cause said processors to perform operations comprising:
transmitting a first frame to a first communication unit; and
transmitting a second frame to a second communication unit;
wherein at least a portion of the first frame is simultaneously transmitted with the second frame;
wherein the first frame and the second frame are coordinated according to a first solicited response for the first frame and a second solicited response for the second frame.

31. The machine-readable medium as recited in claim 30, wherein the first frame and the second frame are further coordinated according to operation type.

32. The machine-readable medium as recited in claim 31, wherein the first frame and the second frame are data transmission frames.

33. The machine-readable medium as recited in claim 31, wherein the first frame and the second frame are Data frames compatible with an IEEE 802.11 standard.

34. The machine-readable medium as recited in claim 30, wherein only one of the first frame and the second frame includes a request for data.

35. The machine-readable medium as recited in claim 30, wherein only one of the first frame and the second frame is frame containing a CF-Poll compatible with an IEEE 802.11 standard.

36. The machine-readable medium as recited in claim 30, wherein the first frame and the second frame are further coordinated according to a frame length of the first frame and a frame length of the second frame.

37. The machine-readable medium as recited in claim 36, wherein the first frame and the second frame are substantially back-end aligned.

38. The machine-readable medium as recited in claim 30, the operations further comprising:
acquiring control of a wireless medium.

39. The machine-readable medium as recited in claim 38, wherein acquiring control of the wireless medium comprises:
setting a network allocation vector in a previous frame to reserve the wireless medium.

40. The machine-readable medium as recited in claim 39, wherein the previous frame is a clear to send frame that is sent omni-directionally.

41. The machine-readable medium as recited in claim 39, wherein the previous frame is a request to send frame that is sent omni-directionally.

42. A system comprising:
one or more dipole antenna(e), through which the system may establish wireless communication with a first communication unit and a second communication unit;
a medium access control layer, coupled to the one or more dipole antenna(e) through a physical layer, to identify a first frame to be communicated to the first communication unit and to identify a second frame to be communicated to the second communication unit, wherein at least a portion of the first frame is simultaneously transmitted with the second frame, and wherein the first frame and the second frame are coordinated according to a first solicited response for the first frame and a second solicited response for the second frame

43. The system as recited in claim 42, wherein the first frame and the second frame are further coordinated according to operation type.

44. The system as recited in claim 42, wherein only one of the first frame and the second frame is a request for data.

45. The system as recited in claim 42, wherein the first frame and the second frame are further coordinated according to a frame length of the first frame and a frame length of the second frame.

46. A method comprising coordinating a plurality of operations to be sent to a plurality of communication units, wherein a portion of each of the plurality of operations is to be sent simultaneously with a portion of each other of the plurality of operations, and wherein the plurality of operations are coordinated according to solicited responses to the plurality of operations.

47. The method as recited in claim 46, wherein the plurality of operations are further coordinated according to operation type.

48. An apparatus comprising:
a medium access control layer, coupled with a first communication unit and a second communication unit through a physical layer, to identify a first frame to be communicated to the first communication unit via the physical layer and to identify a second frame to be communicated to the second communication unit via the physical layer, wherein at least a portion of the first frame is simultaneously transmitted with the second frame, and wherein the first frame and the second frame are coordinated according to a first solicited response for the first frame and a second solicited response for the second frame.

49. The apparatus as recited in claim 48, wherein the plurality of operations are further coordinated according to operation type.
